(19) United States
(12) Patent Application Publication
(10) Pub. No.: US 2008/0196235 A1
(43) Pub. Date: Aug. 21, 2008

(54) CORROSION PROTECTION OF CONTINUOUS SUCKER ROD WELD ZONES

(76) Inventor: Rick Gereluk, Edmonton (CA)

Correspondence Address: PATTERSON & SHERIDAN, L.L.P., 3040 POST OAK BOULEVARD, SUITE 1500, HOUSTON, TX, 77056, US

(21) Appl. No.: 11/675,758

(22) Filed: Feb. 16, 2007

(51) Int. Cl. B23P 25/00

(52) U.S. Cl. 29/527.2

(57) ABSTRACT

The present invention generally relates to corrosion protection of continuous sucker rod weld zones. In one embodiment, a method of manufacturing a continuous sucker rod is provided. The method includes acts of fusing adjacent free ends of adjacent rods together to form one continuous length of rod, said fusing creating a weld zone; treating the weld zone to resist corrosion in a wellbore environment; and winding the continuous length of rod into the continuous sucker rod coil.

### BACKGROUND OF THE INVENTION

1. Field of the Invention

The present invention generally relates to corrosion protection of continuous sucker rod weld zones.

2. Description of the Related Art

In oil and gas wells, a drive string connects a pump, located in a wellbore, to a drive system, located at a surface of the wellbore. Conventional sucker rods are elongated steel rods, typically twenty feet to thirty feet in length, and may be round or oval in cross-section, depending upon the application. A traditional drive string typically includes a sequence of conventional sucker rods with connecting mechanisms at each end of each conventional sucker rod which permit end-to-end interconnection of adjacent rods. In contrast, continuous sucker rod is a unitary rod, including one elongated continuous piece of steel. Thus, continuous sucker rod does not have the numerous interconnection points found in the interconnected conventional sucker rods. Each interconnection point between two successive conventional sucker rods is a source of potential weakness and excess wear on the adjacent tubing and casing.

The length of a drive string can vary from anywhere from as little as five hundred feet to as much as ten thousand feet or more, depending on the depth of the wellbore and desired location of the pump in the wellbore. Continuous sucker rod is typically produced and stored for sale on large transport reels. These transport reels may vary in diameter from about ten feet to about twenty feet or more depending on the mode of transportation used for the reel. A full reel can carry continuous sucker rod with lengths of over six thousand feet depending on the diameter of the rod.

The properties of the steel used for any drive string sucker rod, whether continuous or conventional sucker rod, depend upon the conditions of the well and the drive system and pumping system used to produce the well. Sucker rod is generally classified into grades which are suitable over a range of load conditions and/or environmental conditions, such as hydrogen sulfide (H₂S) and/or carbon dioxide (CO₂) content of the well. An additional consideration for continuous sucker rod is that the steel allows for the rod can be wound tightly enough to fit snugly on the transport reel and then be able to be straightened into a drive string at the well.

Steel used to make continuous sucker rod is received from the steel mill in raw coils. The steel is manufactured by the steel mill to meet specifications as directed by the sucker rod manufacturer. To meet these requirements, the input coils are specially alloyed using known techniques to produce a grade of steel with suitable hardenability, strength, toughness, corrosion resistance, fatigue resistance, micro-cleanliness, and weldability. Usually, a number of the raw coils must be fused together end-to-end to form one continuous sucker rod of the desired length. The ends are usually fused together by welding which creates heat-affected zones (HAZs) adjacent to the fusion zone. For convenience, the fusion zone and the HAZ will be collectively referred to as the weld zone. The weld zone may then be treated to relieve stresses and yielding caused by the welding process.

Due to the high temperatures involved in the welding process, the metallurgical structure of the steel is altered in the weld zone. This alteration negatively affects the corrosion resistance of the weld zone. The reduced corrosion resistance ultimately leads to premature failures of the continuous rod strings in the wellbore at the weld zone. Therefore, there exists a need in the art to increase the corrosion resistance of the weld zone in continuous sucker rod strings.

### SUMMARY OF THE INVENTION

The present invention generally relates to corrosion protection of continuous sucker rod weld zones. In one embodiment, a method of manufacturing a continuous sucker rod is provided. The method includes acts of fusing adjacent free ends of adjacent rods together to form one continuous length of rod, said fusing creating a weld zone; treating the weld zone to resist corrosion in a wellbore environment; and winding the continuous length of rod into the continuous sucker rod coil.

In another embodiment, a continuous sucker rod is provided. The continuous sucker rod is made by a method. The method includes acts of fusing adjacent free ends of adjacent rods together to form one continuous length of rod, said fusing creating a weld zone; treating the weld zone to resist corrosion in a wellbore environment; and winding the continuous length of rod into the continuous sucker rod coil.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic of a method of manufacturing a continuous sucker rod string through a processing facility, according to one embodiment of the present invention.

### DETAILED DESCRIPTION

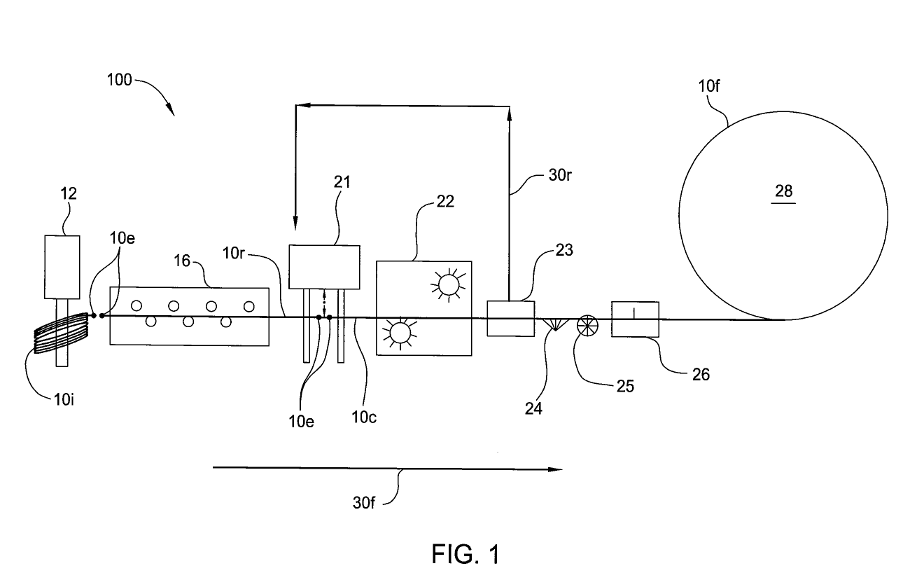

FIG. 1 is a schematic of a method of manufacturing a continuous sucker rod string through a processing facility 100, according to one embodiment of the present invention. Input coils 10i are received from a mill (not shown). The input coils 10i may be in a hot rolled condition and are of desired diameter and specified cross-sectional shape, such as round or oval. Each of the input coils 10i is of a material suitable for a sucker rod, such as an alloy, such as steel, such as American Society for Testing and Materials (ASTM) A576 grade, 1.031 Grade X available from Stelco Inc. of Ontario, Canada, American Petroleum Institute (API) Grade K, API Grade C, API Grade D Carbon, API Grade D Alloy, or API Grade D Special. The hardenability of each of the input coils 10 may be specified to the mill to ensure a minimum tensile strength. Alternatively, the processing facility may include a heat treatment station (not shown) to treat each coil alloy to ensure a minimum tensile and/or yield strength.

Optionally, each of the input coils 10i may be set into a staging area (not shown) of the processing facility 100 for a pre-processing inspection. Each of the input coils 10i may be visually inspected for surface flaws and bends. If these flaws are found to be outside of specifications, they are to be marked for subsequent cut-out or re-work. If the density of the flaws is severe, the input coil 10i may be scrapped prior to processing.

Each of the input coils 10i is placed on a mandrel of an uncoiler 12 and the steel shipping bands (not shown) are removed. The uncoiler 12 supports the input coil 10i during the uncoiling operation and facilitates the orderly uncoiling of the input coil 10i without tangling and kinking, thereby at least substantially shaping each of the input coils 10i into a rod 10r. After uncoiling, each of the rods 10r optionally passes through a two axis, multi-roll rod straightener 16 which performs a cold straightening operation. Each of the coils/rods 10i/r generally proceeds through the processing facility 100 in a forward direction 30f. Each of the rods 10r may be straightened dynamically in the vertical and horizontal axis such that even relatively high yield strength material is successfully straightened to an industry standard, such as API 11B. The straightener 16 acts to straighten and propel each of the rods 10r forward, bending each rod 10r in the opposite direction to an existing bend of the rod 10r from being in the coiled shape.

Upon leaving the straightener 16, each of the rods 10r is passed through a welding station, such as flash-butt welding station. The flash-butt welding station includes an automatic flash-butt welding machine 21. Each longitudinal end 10e of each rod 10r is free. Additional free ends within each of the rods 10r may be created when a flaw marked for cut-out is cut out (discussed below). The cut-out is performed using a shear or cutting torch (not shown). The flash-butt welding machine 21 is used to fuse adjacent free ends 10e of adjacent rods 10r together to form one continuous rod 10c, whether those free ends are adjacent ends from either side of a flaw cut-out or from adjacent free ends of one rod 10r to the next rod 10r in the series.

Flash-butt welding fuses the free ends 10e together in the following manner. Adjacent free ends 10e are clamped in a longitudinally opposing manner by two electrodes of opposite electrical polarity. One electrode is fixed while the other moves in the longitudinal direction. When the electrodes are energized, the rod 10r becomes the electrical conductor of a high current. The electrical current flowing through the rod 10r is converted to heat due to the electrical resistance of the rod 10r. The rod ends 10e heat to a melting temperature of the rod alloy for a brief period before they are rapidly forced together under the action of the moveable electrode. The fusing process of the welding creates a weld zone including a fusion zone and a heat affected zone (HAZ). The continuous welded rod 10c is held in the upset position briefly while the weld zone cools. Upon cooling, the electrodes are unclamped and the weld zone is ground and polished to meet rod body dimensional specifications.

After cooling, the weld zone may be treated to alleviate imperfections induced by the flash-butt welding. This treatment occurs in the flash-butt welding station. The weld zone is reclamped in the electrodes of the flash-butt welding machine 21 and tempered for stress relieving. Stress relieving ensures the weld zone is made free of residual stresses induced during the weld process. After the stress relieving process is complete, the weld zones may be inspected for cracking and incomplete fusion using a standard magnetic particle examination procedure.

Optionally, the continuous rod 10c exiting the flash-butt welding station may be fed through a surface-cleaning station having a surface-cleaning apparatus, such as a multi-wheel shot-peening apparatus 22. The shot-peening apparatus 22 removes an oxide layer, such as iron oxide if the rod material is steel, covering the material. Shot-peening also effectively removes the mill scale and ensures a clean surface for a subsequent surface treatment station 26. However, it is to be understood that other methods of cleaning the mill scale and/or placing the surface of the rod into compression may be used instead of shot-peening, such as sand-blasting.

After exiting the surface-cleaning operation, the surface of the continuous rod 10c is then, optionally, inspected at an inspection station having an inspection device, such as an eddy current flaw detector 23. If sufficiently significant, the flaws are marked with flaw marking equipment 24 for cut-out. Alternative methods of flaw detection may also be used. As each flaw is marked and identified, the continuous rod 10c is stopped and backed up (indicated by arrows 30r) to the flash-butt welding station. A shearing or cutting torch located in the flash-butt welding station is used to cut out the flaws, creating two new free ends which must be fused together using the flash-butt welding machine 22 in the same manner that the free ends of the coils were fused. The new weld will then pass through the surface-cleaning station 22 and the inspection station 23 to be re-inspected.

The continuous rod 10c is accurately measured linearly upon exit of the process by a measuring device, such as a wheel mounted digital encoder 25 running on the moving rod 10c. Accurate length measurements ensure individual rod strings are to customer's requirements and bulk reels of rod comply with transportation weight limits.

After measurement, the continuous rod 10c is driven through a surface treatment station (STS) 26. In the STS 26, each of the weld zones is treated for corrosion protection from the wellbore environment. Such treatment may include a metallic coating, chemical conversion coating, inorganic non-metallic coating, organic coating, and multi-layer combinations thereof. In one aspect, only the weld zones of the continuous sucker rod 10c are treated in the STS 26.

The metallic coating may be any metal or alloy anodic to the rod alloy or chromium, nickel, or chromium over nickel. If the rod alloy is steel, examples of such anodic coatings are magnesium, zinc, beryllium, aluminum, cadmium, and alloy thereof. The metallic coating may be applied by processes, such as cladding, electroplating, electroless plating, diffusion, metallizing (i.e. arc and flame spraying), high-velocity (oxy-fuel) spray coating, plasma vapor deposition, chemical vapor deposition, and weld overlaying.

Examples of the chemical conversion coating for a steel rod alloy are a phosphating process, an oxidizing process, and a chromate surface conversion.

Examples the inorganic non-metallic coating are inorganic zinc silicate and ceramic coatings. The inorganic non-metallic coatings may be applied by high-velocity (oxy-fuel) spray coating or flame spray coating, or arc spray coating.

Examples of the organic coating are epoxy, acrylic, polyurethane, organic zinc, phenolic, epoxy-phenolic, fluorocarbon based, molybdenum disulfide, silicon, and other polymer based coatings. The epoxy, acrylic, polyurethane, organic zinc, and silicon coatings may each also include a carrier component so that when the two are mixed a chemical reaction occurs which assists in the curing and/or drying cycles. The phenolic, epoxy-phenolic, fluorocarbon based, molybdenum disulfide, and silicon coatings may be applied and then heat cured to set.

An example of a multi-layer combination coating is a first metallic layer, such as an anodic metal or alloy layer, such as zinc, and a second organic layer, such as polyurethane.

After surface treatment of each of the weld zones, a bath of atmospheric corrosion inhibitor may be applied to the surface of the continuous rod 10c which prevents the rusting of the continuous sucker rod 10c while stored in inventory (if the rod is made from steel). The inhibitor is pumped over the moving continuous rod 10c and the excess coating is wiped away prior to exiting the coating enclosure. The coated rod 10c is then guided through a series of rollers which wind the continuous rod 10c onto transport reel 28 into a finished coil 10f for storage in inventory and shipment to the field well site.

In an alternative embodiment, it may be possible to avoid backing up the rod to before the welding station 21 after flaw identification at the inspection station 23 occurs by placing an additional welding station immediately after the inspection station 23. In this case, free ends 10e of adjacent rods 10r would be joined at the welding station 21 while cutting out the flaws and fusing the further free ends that are formed by the cutting out process would occur in the second welding station. In this embodiment, the fused areas formed in the second welding station would not be surface-cleaned or themselves inspected for flaws.

In another alternative embodiment, it may be possible to place the surface-cleaning station 22 and the inspection station 23 before the welding station 21. However, if the welds are also to be surface-cleaned and inspected, the continuous rod 10c would have to be backed up prior to both operations in order for the weld zone to be subjected to these treatment steps.

The process facility 100 may be a set of trailers, allowing for transfer of the process facility 100 to permit performance of the manufacturing method in different locations, including at a surface of the wellbore.

While the foregoing is directed to embodiments of the present invention, other and further embodiments of the invention may be devised without departing from the basic scope thereof, and the scope thereof is determined by the claims that follow.

1. A method of manufacturing a continuous sucker rod coil comprising acts of:
fusing adjacent free ends of adjacent rods together to form one continuous length of rod, said fusing creating a weld zone;
treating the weld zone to resist corrosion in a wellbore environment; and
winding the continuous length of rod into the continuous sucker rod coil.

2. The method of claim 1, wherein the treating act comprises coating the weld zone with a metallic coating, chemical conversion coating, inorganic non-metallic coating, or organic coating.

3. The method of claim 2, wherein the treating act comprises coating the weld zone with the metallic coating.

4. The method of claim 3, wherein the rods are made from an alloy, and the metallic coating is a metal or alloy anodic to the rod alloy.

5. The method of claim 4, wherein the alloy is steel and the anodic coating is magnesium, zinc, beryllium, aluminum, cadmium, or alloy thereof.

6. The method of claim 3, wherein the metallic coating is chromium, nickel, or chromium over nickel.

7. The method of claim 3, wherein the coating act comprises cladding, electroplating, electroless plating, diffusion, metallizing, high-velocity oxy-fuel spray coating, plasma vapor deposition, chemical vapor deposition, or weld overlaying.

8. The method of claim 2, wherein the treating act comprises coating the weld zone with the chemical conversion coating.

9. The method of claim 8, wherein the coating act comprises phosphating, oxidizing, or chromate surface conversion coating.

10. The method of claim 2, wherein the treating act comprises coating the weld zone with the inorganic non-metallic coating.

11. The method of claim 10, wherein the inorganic non-metallic coating is inorganic zinc silicate, or ceramic.

12. The method of claim 10, wherein the coating act comprises high-velocity oxy-fuel spray coating, flame spray coating, or arc spray coating.

13. The method of claim 2, wherein the treating act comprises coating the weld zone with the organic coating.

14. The method of claim 13, wherein the organic coating is epoxy, acrylic, polyurethane, organic zinc, phenolic, epoxy-phenolic, fluorocarbon based, molybdenum disulfide, silicon, or other polymer based.

15. The method of claim 2, wherein the coating is a first layer and the method further comprises coating the weld zone with a second layer.

16. The method of claim 15, wherein the second layer is a metallic coating, chemical conversion coating, inorganic non-metallic coating, or organic coating.

17. The method of claim 15, wherein the rods are made from an alloy, the first layer is a metal or alloy anodic to the rod alloy, and the second layer is an organic coating.

18. The method of claim 1, wherein only the weld zone is treated to resist corrosion in the wellbore environment.

19. The method of claim 1, further comprising selecting a plurality of input coils, each input coil having a hardness substantially equal to a predetermined hardness, and each input coil having two free ends;

20. The method of 1, further comprising an act of removing mill scale from the surface of the rod.

21. The method of claim 1, further comprising an act of placing the surface of the rod into compression.

22. The method described in claim 1, further comprising acts of inspecting for flaws and marking flaws for removal.

23. The method described in claim 1, further comprising heat treating the weld zone to alleviate imperfections created by the welding act.

24. A continuous sucker rod coil made by a method, the method comprising acts of:
fusing adjacent free ends of adjacent rods together to form one continuous length of rod, said fusing creating a weld zone;
treating the weld zone to resist corrosion in a wellbore environment; and
winding the continuous length of rod into the continuous sucker rod coil.

25. The continuous sucker rod coil of claim 24, wherein the treating act comprises coating the weld zone with a metallic coating, chemical conversion coating, inorganic non-metallic coating, or organic coating.

26. The continuous sucker rod coil of claim 25, wherein the treating act comprises coating the weld zone with the metallic coating.

27. The continuous sucker rod coil of claim 26, wherein the rods are made from an alloy, and the metallic coating is a metal or alloy anodic to the rod alloy.

28. The continuous sucker rod coil of claim 27, wherein the alloy is steel and the anodic coating is magnesium, zinc, beryllium, aluminum, cadmium, or alloy thereof.

29. The continuous sucker rod coil of claim 26, wherein the metallic coating is chromium, nickel, or chromium over nickel.

30. The continuous sucker rod coil of claim 26, wherein the coating act comprises cladding, electroplating, electroless plating, diffusion, metallizing, high-velocity oxy-fuel spray coating, plasma vapor deposition, chemical vapor deposition, or weld overlaying.

31. The continuous sucker rod coil of claim 25, wherein the treating act comprises coating the weld zone with the chemical conversion coating.

32. The continuous sucker rod coil of claim 31, wherein the coating act comprises phosphating, oxidizing, or chromate surface conversion coating.

33. The continuous sucker rod coil of claim 25, wherein the treating act comprises coating the weld zone with the inorganic non-metallic coating.

34. The continuous sucker rod coil of claim 33, wherein the inorganic non-metallic coating is inorganic zinc silicate, or ceramic.

35. The continuous sucker rod coil of claim 33, wherein the coating act comprises high-velocity oxy-fuel spray coating, flame spray coating, or arc spray coating.

36. The continuous sucker rod coil of claim 25, wherein the treating act comprises coating the weld zone with the organic coating.

37. The continuous sucker rod coil of claim 36, wherein the organic coating is epoxy, acrylic, polyurethane, organic zinc, phenolic, epoxy-phenolic, fluorocarbon based, molybdenum disulfide, silicon, or other polymer based.

38. The continuous sucker rod coil of claim 25, wherein the coating is a first layer and the method further comprises coating the weld zone with a second layer.

39. The continuous sucker rod coil of claim 38, wherein the second layer is a metallic coating, chemical conversion coating, inorganic non-metallic coating, or organic coating.

40. The continuous sucker rod coil of claim 38, wherein the rods are made from an alloy, the first layer is a metal or alloy anodic to the rod alloy, and the second layer is an organic coating.

41. The continuous sucker rod coil of claim 24, wherein only the weld zone is treated to resist corrosion in the wellbore environment.
